(19) United States
(12) Patent Application Publication
(10) Pub. No.: US 2007/0016908 A1
(43) Pub. Date: Jan. 18, 2007

(54) Parallel operation apparatus

(76) Inventor: Manabu Kuroda, Hyogo (JP)

Correspondence Address: MCDERMOTT WILL & EMERY LLP, 600 13TH STREET, N.W., WASHINGTON, DC, 20005-3096, US

(21) Appl. No.: 11/485,989

(22) Filed: Jul. 14, 2006

(30) Foreign Application Priority Data
Jul. 15, 2005 (JP) 2005-207413

(51) Int. Cl. G06F 9/46

(52) U.S. Cl. 718/107

(57) ABSTRACT

A main processor includes a notification control unit that receives a time setting and prevents the reception of a processing completion notification for a predetermined time. Upon instructing a sub processor to start processing, the main processor sets the predetermined time in the notification control unit when switching task processing so as to process a task with a different priority. As a result, the main processor can process the task with a different priority for at least the predetermined time, regardless of a processing time of the sub processor, thereby ensuring real-time ability while processing the task with a different priority.

This application is based on an application no. 2005-207413 filed in Japan, the content of which is hereby incorporated by reference.

### BACKGROUND OF INVENTION

1. Field of the Invention

The present invention relates to a parallel operation apparatus including a special-purpose processor for performing specified processing, and in particular to technology for processing a plurality of tasks by time-division.

2. Related Art

Conventionally, there are parallel operation apparatuses which include not only a general-purpose processor, but also a special-purpose processor that performs specified processing to process a plurality of tasks by time-division. These parallel operation apparatuses realize an increase in operation speed by causing a specified portion of processing to be processed by the special-purpose processor (see Japanese Patent No. 3007612).

The inclusion of a special-purpose processor in a parallel operation apparatus has the very large effect of increasing processing speed, particularly when it is necessary to process a plurality of sequentially generated tasks at high speed in order to maintain real-time ability.

Processing that requires real-time ability is, for example, processing pertaining to real-time recording and playback of image data composed of video and audio. There is processing that is difficult for a general-purpose processor to independently execute while maintaining real-time ability, such as DCT (Discrete Cosine Transform) processing and ME (Motion Estimation) processing in encoding and decoding processing of MPEG (Moving Picture Experts Group) video. However, it is possible to reduce the number of clock cycles required for processing in the general-purpose processor by causing specified large amounts of operations to be processed by a special-purpose processor specialized for such operations. As a result, the parallel operation apparatus can process a plurality of sequentially generated tasks at high speed to maintain real-time ability.

A general-purpose processor in the above-mentioned parallel operation apparatus processes a type 1 and a type 2 task by time-division. The type 1 task is a task of instructing the special-purpose processor to start the required processing when specified processing is required, and the type 2 task is a task of performing processing that can be performed independently by the general-purpose processor. There are cases in which a type 1 task requiring specified processing by the special-purpose processor is processed with higher priority than a type 2 task, and the type 2 task is processed during the time from when the special-purpose processor has been instructed to start the specified processing of the type 1 task until execution completion is notified by the special-purpose processor. When execution completion is notified, interruption or the like is performed by hardware to initiate processing of the type 1 task.

Take for example the case of playing back image data. When playback processing of the MPEG video data is made the type 1 task, and playback processing of the audio data is made the type 2 task, it may be desirable to maintain real-time ability for at least playback processing of the MPEG video data. In this case, the general-purpose processor can keep the video playback processing from failing by executing the video data playback processing with priority over the audio data playback processing as soon as the specified processing is completed by the special-purpose processor.

In task switching by a general OS (Operating System), there is the possibility that the type 1 task cannot be processed in real-time due to overhead occurring during task switching. In this case, the general-purpose processor can process the type 1 task while maintaining real-time ability by reducing the overhead occurring during task switching to a minimum as a result of interruption by hardware or the like.

For example, if it is required to perform task switching in the general-purpose processor according to a time granularity of approximately 24 microseconds to maintain real-time ability, an ordinary OS whose cycles are limited to 100 to 1,000 microseconds cannot process the type 1 task in real-time using round robin scheduling-type task switching since the overhead occurring during task switching is too large. Including the above-mentioned structure, however, enables real-time ability to be maintained while executing task processing.

In this way, the parallel operation apparatus can perform task processing while ensuring real-time ability for the type 1 task, as a result of the type 1 task being processed with priority in the general-purpose processor.

However, although it is possible to ensure real-time ability for the type 1 task in the above-mentioned structure, real-time ability for a type 2 task may not be able to be ensured when necessary.

The reason for this is that the processing time for the type 2 task in the general-purpose processor is dependent on the time that the specified processing of the type 1 task is being executed by the special-purpose processor. This is because the general-purpose processor with the above-mentioned structure executes the processing of the type 1 task with priority over the type 2 task, processes the type 2 task while the specified processing of the type 1 task is being performed by the special-purpose processor, and again processes the type 1 task with priority upon receiving an execution completion notification output by the special-purpose processor when it has finished processing.

In other words, given that the type 2 task is processed in the general-purpose processor while task processing is executed in the special-purpose processor, it becomes difficult for the general-purpose processor to maintain real-time ability for the type 2 task processing if the task processing time in the special-purpose processor is insufficient.

### SUMMARY OF INVENTION

Therefore, the present invention aims to provide a parallel operation apparatus that can process a plurality of tasks by time-division while ensuring real-time ability for each of the tasks.

In order to resolve the stated problem, a parallel operation apparatus of the present invention is a parallel operation apparatus for processing a plurality of sequentially generated tasks by time-division, including: a first processor; and a second processor operable to receive an instruction from the first processor, execute processing, and notify execution completion, wherein the first processor includes a task switching control unit operable to switch task processing by selectively applying (i) a first mode in which the first processor executes a type 1 task with priority after executing a first processing, the type 1 task causing the second processor to start a second processing, and (ii) a second mode in which, when there is a type 2 task that the first processor can process independently, the first processor executes the type 2 task regardless of the existence of the type 1 task, and the task switching control unit applies the second mode upon the first processor executing the type 1 task to instruct the second processor to start the second processing, prevents application of the first mode for at least a predetermined time after applying the second mode, and applies the first mode when the second processing has been completed and the predetermined time has elapsed.

According to this structure, the first processor instructs the second processor to execute the second processing of the type 1 task, and performs processing of the type 2 task from performing the instruction until the predetermined time has elapsed, even if the processing is completed in the second processor before the predetermined time has elapsed. Therefore, the first processor can ensure that the type 2 task is processed at least the predetermined time if it is necessary to maintain real-time ability for the type 2 task. As a result, the first processor can allocate the necessary processing time to execution of the type 2 task, to ensure real-time ability.

For example, in a round-robin method of task scheduling in which task priorities are established according to predetermined time slices, each of the tasks is generally processed by performing task switching according to the determined order and time slices. Therefore, it is generally possible to perform scheduling so as to cause certain task processing to be executed for a predetermined time. If, however, the task processing is completed before the predetermined time has elapsed, another unscheduled task cannot be processed until a remainder of the predetermined time has passed.

In contrast, the first processor of the parallel operation apparatus of the present invention applies the second mode and processes the type 2 task from when the second processor was instructed until at least the predetermined time has elapsed, to process the type 2 task.

Consequently, if certain task processing of the type 2 task is completed before the predetermined time has elapsed, the execution of other type 2 task processing can be started at this time, or processing of the type 1 task can be started if there is no other type 2 task that requires processing. It is therefore possible to perform task switching to ensure real-time ability, and improve utilization of the processor and task processing efficiency compared with a conventional task scheduling method of performing task switching by predetermined time slices.

Also, the task switching control unit may further include a notification control subunit operable to receive a setting of the predetermined time, prevent notification of the execution completion from being received by the first processor until the predetermined time has elapsed, and cancel the prevention on elapse of the predetermined time, after starting application of the second mode, may start application of the first mode on receipt of the notification of the execution completion, upon instructing the second processor to start the second processing, may set the predetermined time in the notification control subunit and start application of the second mode, and may cause the notification control subunit to perform the prevention to prevent application of the first mode until the predetermined time has elapsed.

Also, the task switching control unit may further include a priority control subunit operable to control a priority of a task processed in the first processor, after starting application of the second mode, may start processing of the type 1 task in accordance with the priority thereof on receipt of the notification of the execution completion, upon instructing the second processor to start the second processing, may start application of the second mode by causing the priority control subunit to raise the priority of the type 2 task over the priority of the type 1 task, from application of the second mode until the predetermined time has elapsed, may prevent application of the first mode by causing the priority control subunit to raise the priority of the type 2 task over the priority of the type 1 task, and, after the predetermined time has elapsed, may start application of the first mode by causing the priority control subunit to raise the priority of the type 1 task over the priority of the type 2 task.

According to this structure, the first processor sets its own predetermined time. This enables the first processor to set the predetermined time according to processing content that was executed therein.

Consequently, if for example there is a relationship between processing that has been executed in the first processor and the type 2 task processing time necessary to ensure real-time ability, the first processor can ensure at least the time necessary to process the type 2 task.

Also, the task switching control unit may set the predetermined time to a predetermined fixed value.

According to this structure, processing to calculate the period for preventing application of the first mode after application of the second mode can be omitted since this period is made a fixed value.

Also, the first processor may further include a measurement subunit operable to measure an application period during which the first mode is applied, and the task switching control unit may determine the predetermined time according to the application period that was applied until the instruction was performed.

According to this structure, the type 2 task processing time can be lengthened or shortened according to variations in the type 1 task processing time in the first processor, since the predetermined time is determined according to the period for which the first mode was applied and the type 1 task processing was executed.

Consequently, if for example the type 2 task processing time necessary for maintaining real-time ability varies according to the type 1 task processing time, the first processor can determine a predetermined time according to any variation in the type 1 task processing time in the first processor, to ensure the required type 2 task processing time.

Also, the task switching control unit may determine the predetermined time such that the predetermined time and the application period are in a constant ratio.

According to this structure, task switching in the first processor can be performed more appropriately than conventionally possible if the ratio between the amounts of type 1 task processing type 2 task processing is known in advance, since the time for processing a type 1 task and the time for processing a type 2 task are made to be in a constant ratio.

Also, the task switching control unit may further include a processing request delay subunit operable to receive a predetermined delay time setting, and, from when the first processor performs the instruction until the predetermined delay time has elapsed, delay the start of processing execution by the second processor, upon performing the instruction, may set the delay time in the processing request delay subunit and start application of the second mode, may prevent application of the first mode until the notification of the execution completion is received, and may start application of the first mode upon receiving the notification of the execution completion.

Also, the task switching control unit may further include a completion notification delay unit operable to receive a predetermined delay time, and delay reception of the notification of the execution completion from the second processor until the predetermined delay time has elapsed, when performing the instruction, may set the delay time in the completion notification delay subunit and start application of the second mode, may prevent application of the first mode until the notification of the execution completion is received, and may start application of the first mode upon receiving the notification of the execution completion.

Also, the first processor may further include a sub processor control unit operable to receive a predetermined delay time setting, and, when the second processor is executing processing, cause the execution of the processing to be stopped for the predetermined delay time, and the task switching control unit may, when performing the instruction, set the predetermined delay time in the sub processor control unit and start application of the second mode, upon performing the instruction to cause the second processor to execute processing, may cause the sub processor control unit to stop the processing for the predetermined delay time, may prevent application of the first mode until the notification of the execution completion is received from the sub processor control unit, and may start application of the first mode upon receiving the notification of the execution completion.

According to this structure, the start of processing execution by the second processor, notification of execution completion by the second processor, and completion of processing execution by the sub processor are delayed for at least the predetermined delay time, even if the second processing execution time in the special-purpose processor is shorter than the time required to process the type 2 task in the first processor while maintaining real-time ability. Therefore, the first processor can execute the type 2 task for the required time and maintain real-time ability.

Also, the task switching control unit may set the delay time to a predetermined fixed value.

According to this structure, it is possible to omit processing required to calculate the delay time for delaying the reception of an instruction by the second processor, since the delay time is made a fixed value.

It is desirable to set the delay time as a difference between the type 2 task processing time necessary to ensure real-time ability and the second processing execution time in the second processor. If, for example, the processing time required for execution of the type 2 task is known, and the variation in the second processing execution time in the second processor is small, it is possible to execute task processing that ensures real-time ability even if the delay time is a fixed value as mentioned above, and the performance of the parallel operation apparatus can be further improved.

Also, the first processor further may include a measurement subunit operable to measure an application period during which the first mode is applied, and a processing period estimation unit operable to estimate a processing period based on the instruction, the notification of the execution completion, and the predetermined delay time, the processing period being a period during which the second processor performed processing, and the task switching control unit may determine the predetermined time according to the application period that was applied until performing the instruction, cause the delay time to be a difference between the predetermined time and the estimated processing period, and perform setting of the delay time.

According to this structure, the type 2 task processing time can be lengthened or shortened according to variations in the type 1 task processing time in the first processor, since the predetermined time is determined according to the period for which the first mode was applied and the type 1 task processing was executed.

Consequently, if for example the type 2 task processing time necessary for maintaining real-time ability varies according to the type 1 task processing time, the first processor can determine a predetermined time according to any variation in the type 1 task processing time in the first processor, to ensure the required type 2 task processing time.

Also, each time an instruction is to be output to the second processor, the time for delaying the instruction is determined based on the estimated second processor processing time. Therefore, even if there are variations in the second processor processing time, it is possible to successively change the delay time such that the type 2 task processing is executed for at least the predetermined time.

Also, the present invention is a task switching method for a parallel operation apparatus which is for processing a plurality of sequentially generated tasks by time-division and includes a first processor and a second processor that receives an instruction from the first processor, executes processing, and notifies execution completion, the task switching method including: a task switching control step of switching task processing by selectively applying (i) a first mode in which the first processor executes a type 1 task with priority after executing a first processing, the type 1 task causing the second processor to start a second processing, and (ii) a second mode in which, when there is a type 2 task that the first processor can process independently, the first processor executes the type 2 task regardless of the existence of the type 1 task, and applying the second mode upon the first processor executing the type 1 task to instruct the second processor to start the second processing, preventing application of the first mode for at least a predetermined time after applying the second mode, and applying the first mode when the second processing has been completed and the predetermined time has elapsed.

Using the above-mentioned task switching method enables an improvement in processor performance and task processing efficiency, compared with a conventional task scheduling method that switches tasks according to predetermined time slices.

Also, the present invention is an information processing apparatus using the above parallel operation apparatus.

According to this structure, it is possible to realize an information processing apparatus that enables a plurality of tasks to be processed by time-division while ensuring real-time ability for each of the tasks.

### BRIEF DESCRIPTION OF DRAWINGS

These and other objects, advantages, and features of the invention will become apparent from the following description thereof taken in conjunction with the accompanying drawings, which illustrate specific embodiments of the present invention.

In the drawings:

FIG. 1 is a functional block diagram showing a structure of a parallel operation apparatus according to embodiment 1;

FIG. 2 is a flowchart showing processing performed by an SP 500;

FIG. 3 is a flowchart showing processing performed by a control unit 14 of an MP 100;

FIG. 4 is a flowchart showing processing performed by a notification control unit 13;

FIG. 5 is a flowchart showing processing performed by the control unit 14 to determine a predetermined time to be set in the notification control unit 13;

FIG. 6 shows transitions of tasks whose processing is executed in the MP 100;

FIG. 7 is a functional block diagram showing a parallel operation apparatus pertaining to embodiment 2 of the present invention;

FIG. 8 is a flowchart showing priority switching processing performed by a priority control unit 16;

FIG. 9 is a flowchart showing operations of the control unit 14 in embodiment 2 to execute task processing in accordance with priority;

FIG. 10 shows transitions of tasks whose processing is executed in an MP 110 of embodiment 2;

FIG. 11 is a functional block diagram of a parallel operation apparatus pertaining to embodiment 3 of the present invention;

FIG. 12 is a flowchart showing processing performed by the control unit 14 of embodiment 3;

FIG. 13 is a flowchart showing processing performed by a processing request delay unit 17;

FIG. 14 is a flowchart showing processing performed by the control unit 14 to determine a predetermined time to be set in the processing request delay unit 17; and

FIG. 15 shows transitions of tasks whose processing is executed in an MP 120 of embodiment 3.

### DETAILED DESCRIPTION OF PREFERRED EMBODIMENTS

A parallel operation apparatus pertaining to embodiments of the present invention is described below with reference to the drawings.

### Embodiment 1

Structure

A parallel operation apparatus pertaining to the present invention is composed of a main processor (hereinafter, referred to as “MP”) that manages overall processing, and a sub processor (hereinafter, referred to as “SP”) that executes specified processing based on an instruction from the MP.

The MP prioritizes execution of a type 1 task whose processing requires execution by the SP, and, in order to cause the SP to perform specified processing, outputs to the SP a processing request that requests commencement of processing execution. On output of the processing request, the MP starts executing a type 2 task whose processing can be executed independent of the SP. On receipt of the processing request, the SP executes the specified processing, and outputs a completion notification to the MP upon completing the execution. On receipt of the completion notification, the MP uses an interrupt handler to interrupt a task being processed, and executes the type 1 task with priority.

In the present embodiment, the parallel operation apparatus performs video processing according to, for example, the MPEG (Moving Picture Experts Group) standard, and the MP causes the SP to perform specified processing pertaining to encode processing of the video when playing back image data. While the specified processing is being performed in the SP, the MP performs, for example, audio data playback processing which can be processed independent of the SP. The specified processing in the above example is specifically ME (Motion Estimation) processing and/or DCT (Discrete Cosine Transform) processing, and the type 2 task is the above-mentioned audio data processing and/or processing accompanying the display of subtitles, and the like.

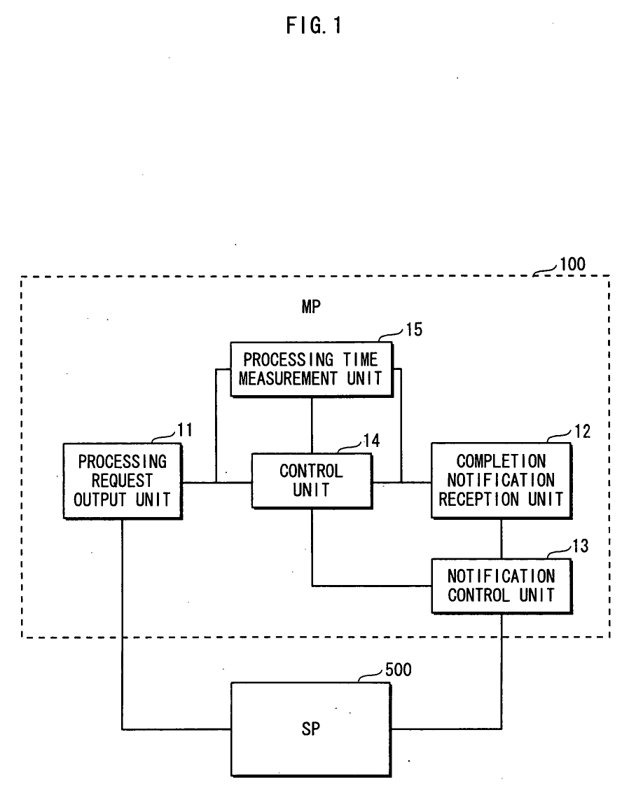

FIG. 1 is a functional block diagram showing a structure of the parallel operation apparatus of the present embodiment.

As shown in FIG. 1, the parallel operation apparatus is composed of an MP 100 and an SP 500, and the MP 100 is an operation apparatus including a processing request output unit 11, a completion notification reception unit 12, a notification control unit 13, a control unit 14, and a processing time measurement unit 15.

In accordance with an instruction from the control unit 14, the processing request output unit 11 outputs, to the SP 500, a processing request which is a predetermined signal for causing the SP 500 to start the specified processing.

The completion notification reception unit 12 receives a completion notification output from the SP 500, and outputs a predetermined signal to the control unit 14.

The notification control unit 13 includes a down counter, and is a circuit that receives a completion notification output from the SP 500, receives a time setting instruction from the control unit 14, and, for a predetermined time, prevents the completion notification output by the SP 500 from being received by the completion notification reception unit 12. For example, the notification control unit 13 uses an AND circuit to output a predetermined signal to the completion notification reception unit 12 when a signal indicating that the completion notification was received from the SP 500 as well as a signal indicating that a time set by the control unit 14 in the down counter has elapsed are both active.

The control unit 14 includes a CPU (Central Processing Unit), a ROM (Read Only Memory), and a RAM (Random Access Memory), and controls execution of task processing and processing performed by the MP 100 in accordance with a program stored in the ROM. When causing the SP 500 to perform the specified processing, the control unit 14 instructs the processing request output unit 11 to output a processing request, and receives, via the completion notification reception unit 12, a completion notification output from the SP 500. The control unit 14 also sets a time in the notification control unit 13.

The processing time measurement unit 15 includes a counter, and is a circuit that measures a time for which the type 1 task was processed in the control unit 14, and outputs the measured time to the control unit 14. The processing time measurement unit 15 measures the time based on a processing request output instruction from the control unit 14 and the predetermined signal that was output by the completion notification reception unit 12.

For example, the processing time measurement unit 15 measures time by using a point at which the completion notification reception unit 12 receives the output signal as a start point, and a point at which the control unit 14 instructs the output of the processing request as an end point. The processing time measurement unit 15 outputs, to the control unit 14, a difference between the start point and the end point as the time for which the type 1 task was processed in the control unit 14.

The SP 500 is a special-purpose processor specialized for, for example, ME processing. The SP 500 receives the processing request output from the MP 100 and starts processing, and outputs a completion notification to the MP 100 upon finishing the processing.

Operation

Next is a description of processing performed by the parallel operation apparatus, with reference to the drawings.

Processing of the SP 500

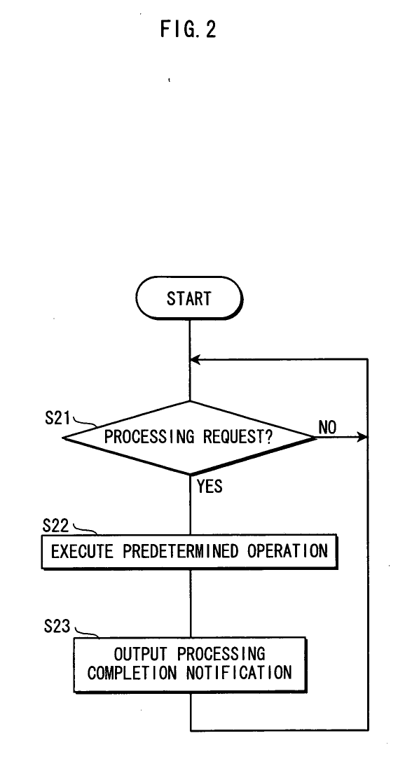

FIG. 2 is a flowchart showing processing performed by the SP 500.

On receipt of a processing request output from the MP 100 (step S21:YES), the SP 500 starts execution of specified processing (step S22), and, upon finishing the execution, outputs a completion notification to the MP 100 (step S23). Thereafter, each time a processing request is received (step S21), the SP 500 executes specified processing (step S22, step S23).

Processing of the MP 100

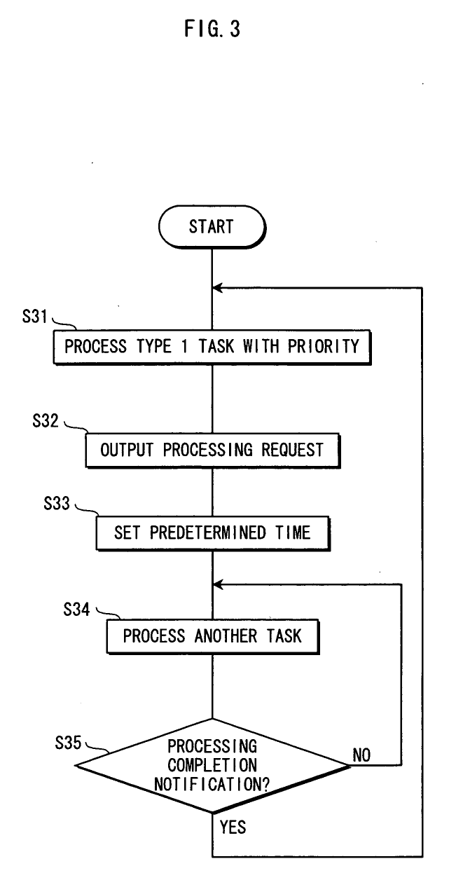

FIG. 3 is a flowchart showing processing performed by the control unit 14 of the MP 100.

The control unit 14 executes the processing of tasks, with higher priority given to a type 1 task over other tasks (step S31). If execution of specified processing by the SP 500 becomes necessary when the MP 100 is executing the processing of a type 1 task, the MP 100 instructs the processing request output unit 11 to output a processing request to the SP 500 (step S32). At this time, the MP 100 determines a time for which to prevent a completion notification output by the SP 500 from being received by the completion notification reception unit 12, and sets the determined time in the notification control unit 13 (step S33). Processing of the notification control unit 13 and processing to determine the time to be set therein are described later.

Upon instructing the output of the processing request, the control unit 14 executes the processing of a type 2 task (step S34) if present, until the processing completion notification is received via the completion notification reception unit 12 (step S35:NO). Upon receiving the processing completion notification (step S35:YES), the control unit 14 prioritizes execution of the processing of the type 1 task (step S31) if present.

Processing of the Notification Control Unit 13

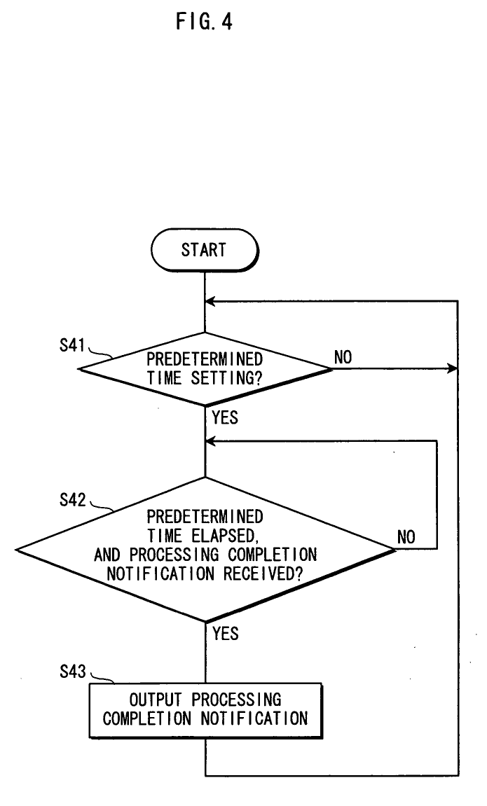

FIG. 4 is a flowchart showing processing performed by the notification control unit 13.

On receipt of the time setting from the control unit 14, the notification control unit 13 sets the included down counter to the predetermined time (step S41:YES).

Even if the completion notification is received from the SP 500, the notification control unit 13 prevents the completion notification from being output until the predetermined time set in the down counter has elapsed (step S42:NO), so that the completion notification is not received by the completion notification reception unit 12. After the predetermined time set in the down counter has elapsed, and if the completion notification has been received from the SP 500 (step S42:YES), the notification control unit 13 directly outputs the completion notification to the completion notification reception unit 12 (step S43). If a completion notification has not been received from the SP 500 after the predetermined time set in the down counter has passed, the notification control unit 13 waits until a completion notification is received (step S42:YES), and then outputs the completion notification to the completion notification reception unit 12 (step S43).

Upon outputting the completion notification, the notification control unit 13 waits until a time setting is again received from the control unit 14 (step S41:NO).

Processing to Determine the Predetermined Time

The following describes how the control unit 14 sets a predetermined time in the notification control unit 13 in step S33 of FIG. 3.

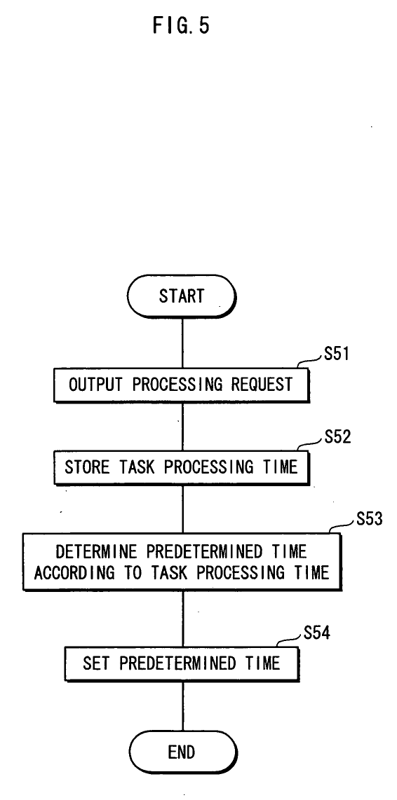

FIG. 5 is a flowchart showing processing performed by the control unit 14 to determine the predetermined time to be set in the notification control unit 13.

Upon instructing the processing request output unit 11 to output a processing request (step S51), the control unit 14 stores, in the RAM, a type 1 task processing time that was output to the control unit 14 by the processing time measurement unit 15 (step S52). The processing time measurement unit 15 measured the type 1 task processing time using the processing request output instruction as an end point. The control unit 14 determines the predetermined time to be set in the notification control unit 13, according to the stored type 1 task processing time (step S53). Upon determining the predetermined time, the control unit 14 sets the predetermined time in the notification control unit 13 (step S54).

Note that although the predetermined time to be set in the notification control unit 13 is determined according to the stored type 1 task processing time in step S53, it is preferable to set a constant ratio between the predetermined time and the stored type 1 task processing time if there is known to be a ratio between the amounts of operations necessary for processing of the type 1 task and the type 2 task. Setting a constant ratio between the processing times of the type 1 task and the type 2 task with respect to small amounts of time granularity enables this ratio to come closer to being constant over a longer period, even if the processing time of the type 1 task varies.

For example, assume in the case of playing back image data that video data playback processing is the type 1 task and audio data playback processing is the type 2 task. If a ratio between the amount of operations necessary for video data playback processing and audio data playback processing in the MP 100 is known in advance, it is sufficient to set a constant ratio between the processing times of the type 1 task and the type 2 task.

Also, the predetermined time to be set in the notification control unit 13 in step S53 may be set to a fixed value. For example, if a ratio between the amounts of operations necessary for processing of the type 1 task and the type 2 task is known, and variation in the processing time of the type 1 task in the MP 100 is not significant, the processing to determine the predetermined time can be omitted by making the predetermined time a fixed value. As a result, it is possible to reduce the amount of operations performed by the MP 100.

The above was a description of processing performed by the parallel operation apparatus pertaining to embodiment 1 of the present invention. The following is a supplementary description of how tasks processed in the MP 100 are switched, with reference to the drawings.

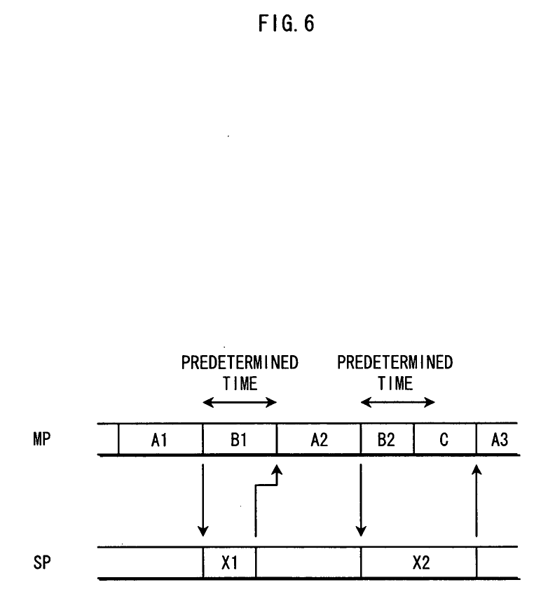

FIG. 6 shows transitions of tasks whose processing is executed in the MP 100.

From among the tasks processed by the MP 100 in FIG. 6, a task A shown by A1, A2, . . . is a type 1 task, and tasks other than the task A are type 2 tasks. In other words, a task B shown by B1, B2, . . . , and a task C are type 2 tasks. Task A and task B are tasks whose processing requires real-time ability.

Also, a task X shown by X1, X2, . . . is a task being processed by the SP 500. The SP 500 receives a processing request output from the MP 100 and starts processing execution, and outputs a completion notification to the MP 100 upon finishing the processing.

Taking an example from FIG. 6, the MP 100 executes the processing of a task A1, and, upon outputting a processing request to the SP 500, switches task processing to execute the processing of a task B1. At this time, the MP 100 sets the predetermined time in the notification control unit 13, and the SP 500 receives the processing request and starts executing the processing of a task X1. If the processing of the task X1 is completed before the predetermined time set in the notification control unit 13 has elapsed, the notification control unit 13 prevents the output of the completion notification until the predetermined time has elapsed.

The MP 100 starts the processing of a task A2 when the predetermined time has elapsed and when the completion notification has been received. Upon outputting a new processing request to the SP 500, the MP 100 determines a new predetermined time, sets the new predetermined time in the notification control unit 13, and also switches task processing to execute the processing of a task B2.

The processing of the task B2 in the MP 100 is completed before the predetermined time elapses. Also, although the SP 500 receives the new processing request output from the MP 100 and starts executing the processing of a task X2, the task X2 processing time in the SP 500 may be longer than the new predetermined time, as shown in FIG. 6.

If the processing of the task B in the MP 100 is completed before the predetermined time has elapsed, or if the time required to process the task X in the SP 500 is longer than the predetermined time, the MP 100 can execute the processing of task C during the time from after the processing of the task B is complete until receipt of a completion notification output by the SP 500.

According to this structure, the MP 100 ensures that the task B is processed at least the predetermined time if the task X processing time in the SP 500 is shorter than the predetermined time. If the task X processing time in the SP 500 is longer than the predetermined time, the MP 100 can execute the processing of the task B until receipt of a completion notification output from the SP 500, and can execute the processing of another task if the processing of task B is completed. Therefore, the parallel operation apparatus of the present invention can increase the amount of operations executed in the MP 100, compared to executing the processing of the tasks A and B per predetermined time slices.

### Embodiment 2

Next is a description of another embodiment of the present invention with focus on differences from embodiment 1. Note that descriptions of portions with the same structure and performing the same operations as embodiment 1 are omitted. In embodiment 2, the MP starts execution of a type 1 task in accordance with a task priority on receipt of a completion notification.

Structure

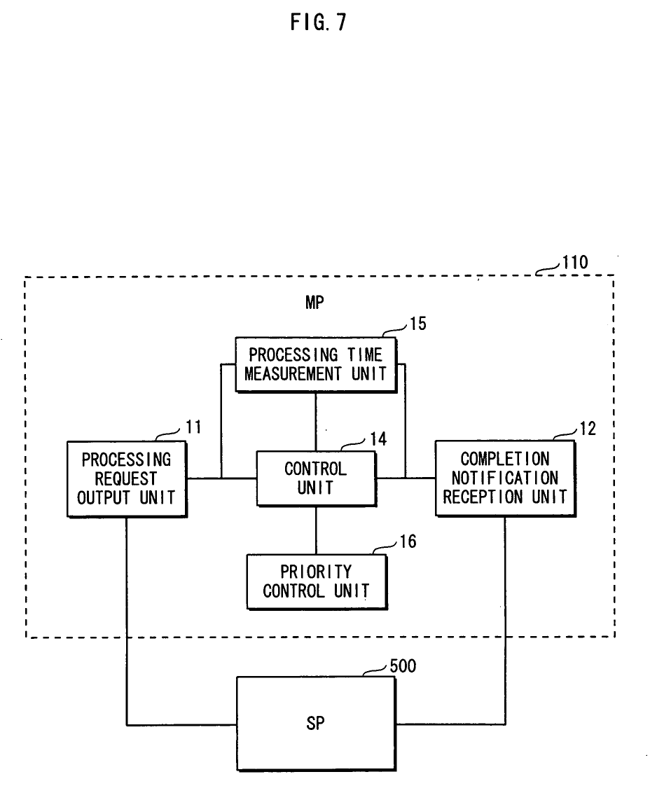

FIG. 7 is a functional block diagram showing a parallel operation apparatus pertaining to embodiment 2 of the present invention.

As shown in FIG. 7, the parallel operation apparatus of embodiment 2 is composed of an MP 110 and an SP 500, and the MP 110 includes a priority control unit 16.

When instructing the output of a processing request to the SP 500, the control unit 14 sets, in the priority control unit 16, a time for switching the priority of a task to be processed. The control unit 14 outputs information pertaining to the set time to the processing time measurement unit 15 as well as the priority control unit 16.

The priority control unit 16 controls the priority of tasks to be processed in the control unit 14. On receipt of the time setting from the control unit 14, the priority control unit 16 sets the time for switching priority, and switches the priority of a task to be processed in the control unit 14 such that the type 2 task is executed with priority until the set predetermined time has elapsed.

The processing time measurement unit 15 measures the time during which a type 1 task is processed in the control unit 14. The processing time measurement unit 15 also receives the information pertaining to the time that the control unit 14 set in the priority control unit 16.

For example, after the control unit 14 instructed the output of a processing request to the SP 500, and if a completion notification is received from the SP 500 before the predetermined time set by the control unit 14 has elapsed, the processing time measurement unit 15 sets the point at which the predetermined time elapses as the start point. If the completion notification is received from the SP 500 after the predetermined time has elapsed, the processing time measurement unit 15 sets the point at which the completion notification was received as the start point. Also, the processing time measurement unit 15 sets the end point as the point at which the control unit 14 processed the type 1 task and output a processing request.

The processing time measurement unit 15 outputs, to the control unit 14, a difference between the measured start point and end point as a time for which the type 1 task was processed in the control unit 14.

Operation

Next is a description of processing performed by the parallel operation apparatus of embodiment 2.

Processing of the Priority Control Unit 16

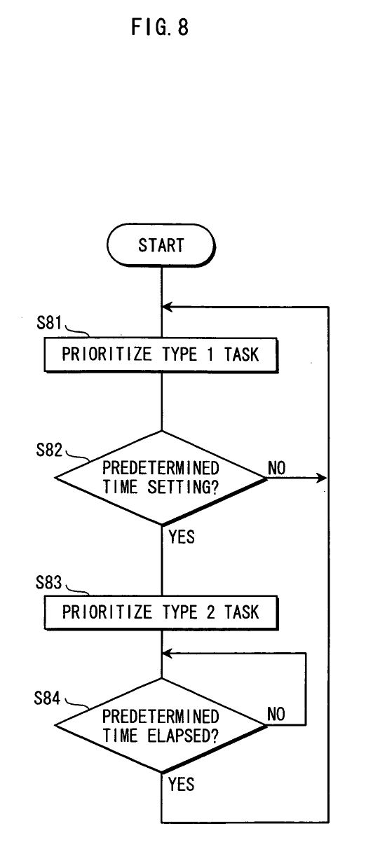

FIG. 8 is a flowchart showing priority switching processing performed by the priority control unit 16.

The priority control unit 16 controls the priority of tasks to be processed in the control unit 14 such that the type 1 task is processed with priority (step S81) until there is a predetermined time setting from the control unit 14 (step S82:NO). On receipt of a predetermined time setting (step S82:YES), the priority control unit 16 switches the priority of tasks to be processed such that the type 2 task is executed in the control unit 14 with priority (step S83).

The type 2 task is processed with priority from when the predetermined time setting was received until the predetermined time has elapsed (step S84:NO). When the predetermined time has elapsed (step S84:YES), the priority control unit 16 switches the priority of tasks to be processed in the control unit 14 such that the type 1 task is executed with priority (step S81).

Processing of the Control Unit 14

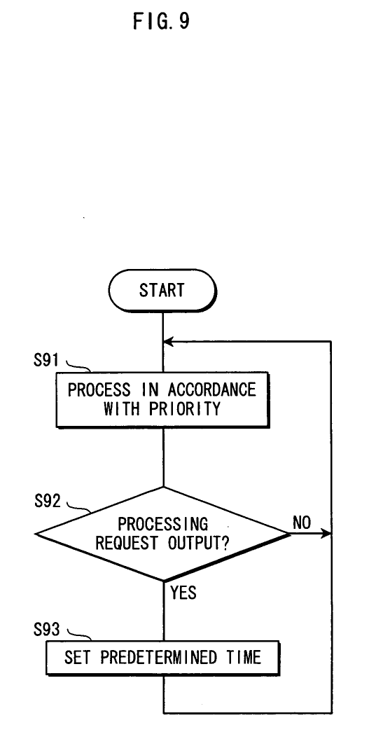

FIG. 9 is a flowchart showing operations of the control unit 14 in embodiment 2 to execute task processing in accordance with priority.

The control unit 14 executes task processing in accordance with priority (step S91), and, upon instructing the output of a processing request to the SP 500 (step S92:YES), sets a predetermined time in the priority control unit 16 (step S93). Upon setting the predetermined time, the control unit 14 executes task processing in accordance with priority (step S91).

Note that the method of determining the predetermined time to be set in the priority control unit 16 is the same as in embodiment 1, whereby the time is determined based on the type 1 task processing time measured by the processing time measurement unit 15, such that there is a constant ratio between the type 1 processing time and the predetermined time.

Note that the predetermined time may be set to a fixed value, the same as in embodiment 1.

Next is a supplementary description of how tasks to be processed in the MP 110 of the parallel operation apparatus pertaining to the above-mentioned embodiment 2 are switched, with reference to the drawings.

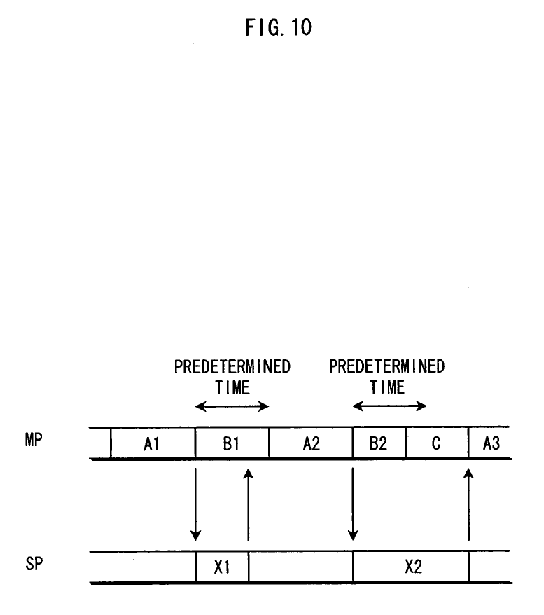

FIG. 10 shows transitions of tasks whose processing is executed in the MP 110.

As described in embodiment 1, task A processed in the MP 110 is the type 1 task, and other tasks processed in the MP 110 are type 2 tasks. Task X is a task processed in the SP 500. The tasks A and B are tasks whose processing requires real-time ability, and on receipt of a completion notification from the SP 500, the MP 110 starts execution of the type 1 task in accordance with priority.

Taking an example from FIG. 10, the MP 110 executes the processing of a task A1, and sets the predetermined time in the priority control unit 16 upon outputting a processing request to the SP 500.

The MP 110 executes a task B1 when the priority of tasks to be processed in the MP 110 is switched by the priority switching control of the priority control unit 16 such that type 2 tasks are executed with priority. Even if a task A2 is generated before the predetermined time has elapsed, the MP 110 starts executing the task A2 after executing the task B1 for the predetermined time, since the type 2 task is executed with priority from after the processing request is output until the predetermined time has elapsed.

Upon finishing the processing of the task A2 and outputting a processing request to the SP 500, the MP 110 sets a predetermined time in the priority control unit 16. When the SP 500 receives the processing request output from the MP 110 and starts processing of a task X2, the task X2 processing time in the SP 500 may be longer than the predetermined time set in the priority control unit 16, as shown in FIG. 10.

In this case, although the priority of tasks to be processed is switched by the priority control unit 16 when the predetermined time has elapsed such that the type 1 task is executed with priority, the type 2 task can be executed even after the predetermined time has elapsed if there is no type 1 task.

### Embodiment 3

Next is a description of another embodiment of the present invention with focus on differences from embodiment 1. Note that descriptions of portions with the same structure and performing the same operations as embodiment 1 are omitted.

Structure

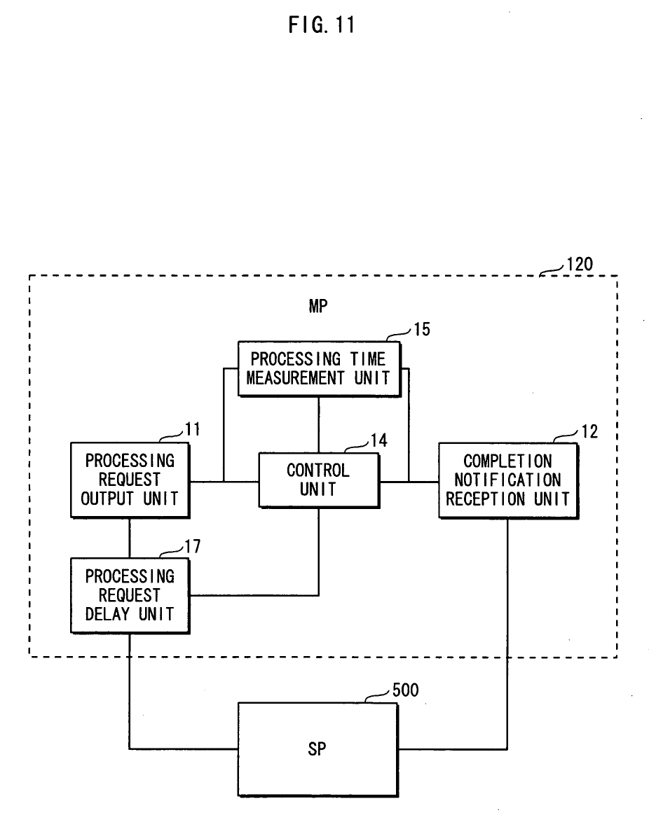

FIG. 11 is a functional block diagram of a parallel operation apparatus pertaining to embodiment 3 of the present invention.

As shown in FIG. 11, the parallel operation apparatus of embodiment 3 is composed of an MP 120 and the SP 500, and includes a processing request delay unit 17.

When instructing the processing request output unit 11 to output a processing request, the control unit 14 sets a time in the processing request delay unit 17. The control unit 14 also outputs information pertaining to the set time to the processing time measurement unit 15 as well as the processing request delay unit 17.

The processing time measurement unit 15 outputs, to the control unit 14, a time for which the type 1 task was processed in the control unit 14. The output time is based on a processing request output instruction from the control unit 14 and a predetermined signal output by the completion notification reception unit 12 that received a completion notification. Furthermore, the processing time measurement unit 15 receives, from the control unit 14, the information pertaining to the time set in the processing request delay unit 17, and estimates a time for which the SP 500 performed processing, based on the received set time information, the processing request, and the completion notification. The processing time measurement unit 15 then outputs the estimated SP processing time to the control unit 14.

For example, assuming the time from when the MP 120 outputs the processing request until the completion notification is received is a type 2 task occupied time, the processing time of the SP 500 can be estimated by subtracting the time set in the processing request delay unit 17 from the type 2 task occupied time.

The processing request delay unit 17 includes a down counter, and is a circuit that along with receiving the processing request output from the processing request output unit 11, receives a time setting instruction from the control unit 14, and, for the predetermined time, prevents the processing request output from the processing request output unit 11 from being received by the SP 500. The processing request delay unit 17 outputs the processing request to the SP 500 when the set time has elapsed, and thereafter is again set with a new predetermined time and prevents the output of another processing request until the new predetermined time has elapsed.

Operation

Next is a description of processing performed by the parallel operation apparatus with reference to the drawings.

Processing of the MP 120

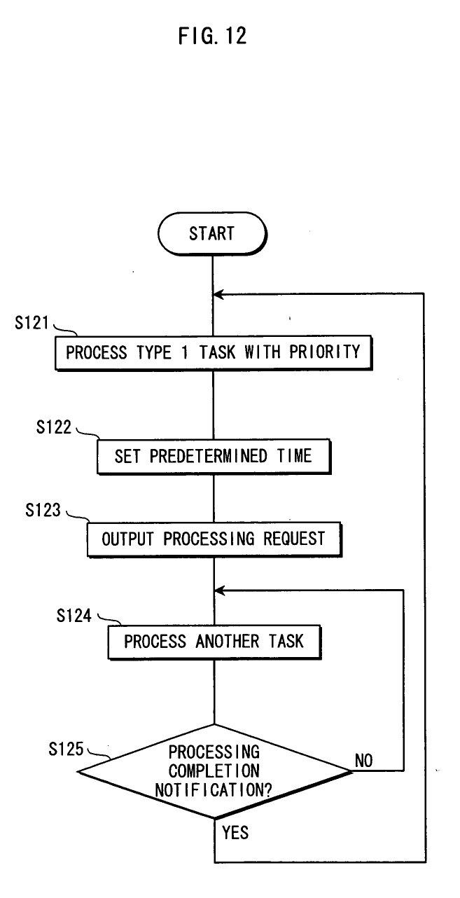

FIG. 12 is a flowchart showing processing performed by the control unit 14 of embodiment 3.

The control unit 14 executes the processing of tasks, with higher priority given to the type 1 task over other tasks (step S121). If execution of specified processing by the SP 500 becomes necessary while executing the processing of the type 1 task, the control unit 14 determines a time for which the processing request delay unit 17 is to delay a processing request from being received by the SP 500, and sets the determined time in the processing request delay unit 17 (step S122). Upon setting the time, the control unit 14 instructs the processing request output unit 11 to output the processing request (step S123). Processing to determine the set time is described later.

The control unit 14 processes another task upon instructing the output of the processing request (step S123), and until a processing completion notification is received via the completion notification unit 12 (step S125:NO). If there is a type 2 task, the control unit 14 switches task processing to execute the processing of the type 2 task (step S124). On receipt of the processing completion notification (step S125:YES), the control unit 14 executes the processing of the type 1 task with priority (step S121), if present.

Processing of the Processing Request Delay Unit 17

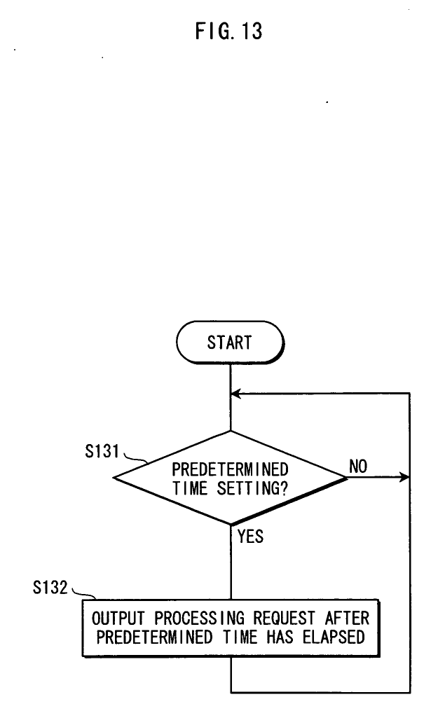

FIG. 13 is a flowchart showing processing performed by the processing request delay unit 17.

On receipt of a predetermined time setting from the control unit 14, the processing request delay unit 17 sets the predetermined time in the included down counter (step S131:YES). When the processing request is received, and the predetermined time set in the down counter has elapsed, the processing request delay unit 17 outputs the received processing request to the SP 500 (step S132).

Predetermined Time Determination Processing

The control unit 14 sets a predetermined time in the processing request delay unit 17 in step S122 of FIG. 12. The following describes a method of determining this predetermined time.

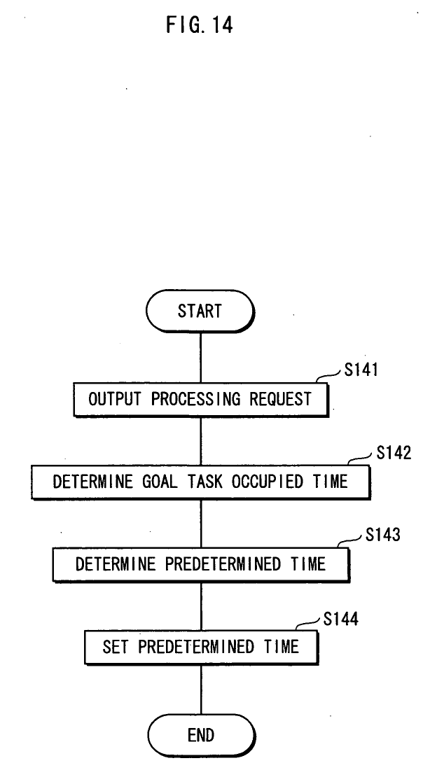

FIG. 14 is a flowchart showing processing performed by the control unit 14 to determine the predetermined time to be set in the processing request delay unit 17.

Upon instructing the output of a processing request (step S141), the control unit 14 determines a goal type 2 task occupied time based on a type 1 task processing time measured by the processing time measurement unit 15. The goal type 2 occupied time is a time for which a type 2 task is executed in the control unit 14 (step S142), and is determined such that, for example, there is a constant ratio between the type 1 task processing time and the goal type 2 task occupied time.

The control unit 14 calculates a difference between the determined goal type 2 task occupied time and an SP processing time output by the processing time measurement unit 15 when the instruction was made, and determines the predetermined time to be the calculated difference (step S143). Upon determining the predetermined time, the control unit 14 sets the predetermined time in the processing request delay unit 17 (step S144).

In this way, the control unit 14 determines the goal type 2 task occupied time based on the type 1 task processing time, and determines the predetermined time based on the goal type 2 task occupied time. Furthermore, even if there are variations in the processing time of the SP 500, the control unit 14 can more accurately determine the predetermined time based on the estimated SP processing time.

Next is a supplementary description of how tasks processed in the MP 120 of the parallel operation apparatus pertaining to the above-mentioned embodiment 3 are switched, with reference to the drawings.

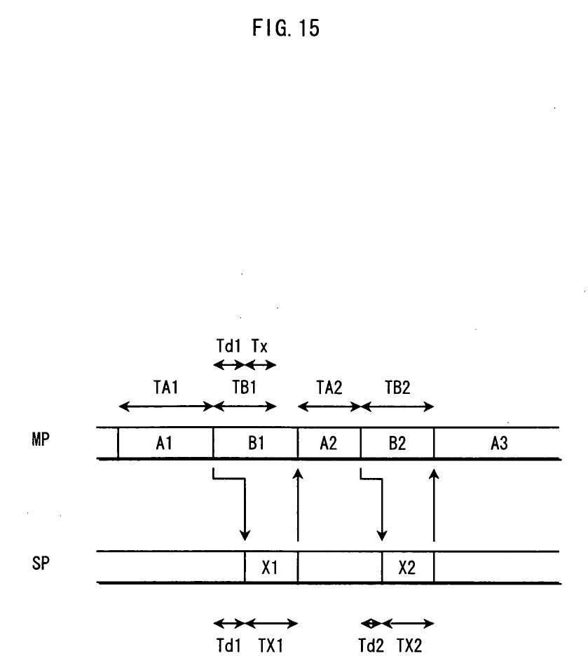

FIG. 15 shows transitions of tasks whose processing is executed in the MP 120.

As described in embodiment 1, a task A processed in the MP 120 is the type 1 task, and other tasks processed in the MP 120 are type 2 tasks. A task X is a task processed in the SP 500.

Note that the MP 120 starts executing processing from the task A1, and preholds an estimated value Tx of the SP 500 processing time.

Also, the processing times of each of the tasks in the MP 120 and the SP 500 are given the following notations. For example, the processing time of the task A1 is TA1, the processing time of the task A2 is TA2, . . . , and the processing times of the task X are TX1, TX2, and so on.

Also, goal task B occupied times in the MP 120 are TB1, TB2, and so on.

Regarding the predetermined times to be set in the processing request delay unit 17, Td1 is a delay time to be set when the task A1 is executed and a processing request is output, Td2 is a delay time to be set when the task A2 is executed and a processing request is output, and so on.

Taking an example from FIG. 15, the MP 120 executes the processing of the task A1, and, upon outputting a processing request to the SP 500, determines a goal type 2 task occupied time TB1 based on a task A1 processing time TA1 in the MP 120. Upon determining the TB1, the MP 120 reads the preheld estimated value Tx of the SP 500 processing time, and determines the predetermined time as Td1=TB1−Tx.

When processing of the task X1 is completed, and upon receiving a completion notification, the MP 120 starts executing the processing of the task A2. At this time, the processing time measurement unit 15 estimates a processing time X1 of the task X1 in the SP 500.

When executing the processing of the task A2 and outputting a processing request to the SP 500, the MP 120 determines a goal type 2 task occupied time TB2 based on a task A2 processing time TA2 in the MP 120. Upon determining the TB2, the MP 120 uses the TX1 estimated by the processing time measurement unit 15 rather than Tx, obtains Td2 from Td2=TB1−TX1, and determines the predetermined time to be the obtained Td2.

Even if processing times of the SP 500 vary, the MP 120 can successively make corrections, in response to the variations, to the predetermined times calculated based on goal type 2 task processing times, since the MP 120 sequentially obtains estimated values of SP 500 processing times and determines predetermined times based on the estimated values. For example, the MP 120 calculates TB1, and sets Td1 as the difference between TB1 and Tx. However, if a sum of Td1 and TX1 is greater than TB1 due to the fact that the actual processing time TX1 of the SP 500 is longer than Tx, the MP 120 can bring the type 2 task processing time closer to the goal type 2 task occupied time by determining the next Td2 based on the actual processing time TX1 of the SP 500.

Supplement

Although described above based on the embodiments, the present invention is not limited to the above-mentioned embodiments. The following variations are also included in the present invention.

(1) Although described as being a part of the MP 100 in embodiment 1, the notification control unit 13 is not limited to this. The notification control unit 13 may be included separately from the MP 100.

Also, although described as being a part of the MP 110 in embodiment 2, the priority control unit 16 is not limited to this. The priority control unit 16 may be included separately from the MP 110.

Also, although described as being a part of the MP 120 in embodiment 3, the processing request delay unit 17 is not limited to this. The processing request delay unit 17 may be included separately from the MP 120.

(2) Although described as a part of the MP 100, the MP 110 and the MP 120 in the above-mentioned embodiments, the processing time measurement unit 15 is not limited to this. The processing time measurement unit 15 may be included separately from the MP 100, the MP 110 and the MP 120.

(3) Although the priority control unit 16 is described in embodiment 2 as having a separate structure from the control unit 14 and performing processing separate from the control unit 14, the processing performed by the priority control unit 16 may instead be executed by the control unit 14.

(4) Although described in embodiment 3 as a difference between the goal type 2 task occupied time and the SP processing time, the predetermined time set in the processing request delay unit 17 is not limited to this. This predetermined time may be a predetermined fixed value.

(5) Although described in embodiment 1 as being determined according to the type 1 task processing time each time a processing request is output, the predetermined time set in the notification control unit 13 is not limited to this. This predetermined time may be determined based on a plurality of type 1 task processing times.

Also, the predetermined time set in the priority control unit 16 in embodiment 2 may be determined based on a plurality of type 1 task processing times.

Also, although described in embodiment 3 as being determined using the SP processing time estimated by the processing time measurement unit 15 each time a processing request is output, the predetermined time set in the processing request delay unit 17 is not limited to this. This predetermined time may be determined based on a plurality of estimated SP processing times.

(6) Although the timing according to which the completion notification output from the SP is received by the MP is controlled by the notification control unit 13 and the processing request delay unit 17 in embodiments 1 and 3 respectively, the timing control is not limited to this. Software on the SP may be used to control the timing according to which the completion notification is output.

(7) Although described in the above-mentioned embodiments as a special-purpose processor for increasing the speed of operation processing such as ME processing, the SP 500 is not limited to this. The SP 500 may have applicability generally to a processor for starting processing as a result of a processing request from the MP. The SP 500 may also have applicability to a case of causing an external processing apparatus to perform, for example, communication processing, data multiplex processing, demultiplex processing, transfer processing, and analysis processing.

(8) In embodiment 1, even if processing of the type 2 task in the MP 100 is completed, output of a completion notification to the MP 100 is prevented until the time set in the notification control unit 13 has elapsed. The present invention, however, is not limited to this. Processing by the notification control unit 13 may be stopped if processing of the type 2 task in the MP 100 is completed.

According to this structure, if processing of the type 2 task in the MP 100 is completed before the predetermined time has elapsed, the MP 100 can receive a completion notification without waiting for the predetermined time to elapse.

(9) Although described in the singular in the above-mentioned embodiments, there may a plurality of SPs. For example, the present invention can be applied by outputting a completion notification to the MP when all the SPs have finished processing.

(10) Although the receipt of a processing request by the SP is delayed for a predetermined time when the MP outputs the processing request in embodiment 3, the present invention is not limited to this. The receipt by the MP of a processing completion notification output by the SP may be delayed for the predetermined time. The present invention may be realized by, for example, providing a completion notification delay unit between the SP 500 and the completion notification reception unit 12. The completion notification delay unit includes a down counter, and is a circuit that along with receiving a completion notification output from the SP 500, receives a time setting instruction from the control unit 14; from receipt of the completion notification and for the predetermined time, delays the completion notification from being received by the completion notification reception unit 12; and on elapse of the predetermined time, outputs the completion notification to the completion notification reception unit 12.

Also, processing performed by the SP may be stopped for the predetermined time if the MP can control operations of the SP.

(11) FIG. 6 and FIG. 10 were used in embodiments 1 and 2 to describe transitions of tasks processed in the parallel operation apparatus. However, in the case of using a round-robin method to periodically switch tasks B and C, processing may switch to task C according to switch timing even if the processing of task B is not complete.

(12) The present invention may be a task switching method as described above.

(13) The above embodiments and the above variations may be combined.

(14) An information processing apparatus using the above-mentioned parallel operation apparatus or the above-mentioned task switching method is included in the present invention.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A parallel operation apparatus for processing a plurality of sequentially generated tasks by time-division, comprising:
a first processor; and
a second processor operable to receive an instruction from the first processor, execute processing, and notify execution completion, wherein
the first processor includes
a task switching control unit operable to switch task processing by selectively applying (i) a first mode in which the first processor executes a type 1 task with priority after executing a first processing, the type 1 task causing the second processor to start a second processing, and (ii) a second mode in which, when there is a type 2 task that the first processor can process independently, the first processor executes the type 2 task regardless of the existence of the type 1 task, and
the task switching control unit applies the second mode upon the first processor executing the type 1 task to instruct the second processor to start the second processing, prevents application of the first mode for at least a predetermined time after applying the second mode, and applies the first mode when the second processing has been completed and the predetermined time has elapsed.

2. The parallel operation apparatus of claim 1, wherein
the task switching control unit
further includes a notification control subunit operable to receive a setting of the predetermined time, prevent notification of the execution completion from being received by the first processor until the predetermined time has elapsed, and cancel the prevention on elapse of the predetermined time,
after starting application of the second mode, starts application of the first mode on receipt of the notification of the execution completion,
upon instructing the second processor to start the second processing, sets the predetermined time in the notification control subunit and starts application of the second mode, and
causes the notification control subunit to perform the prevention to prevent application of the first mode until the predetermined time has elapsed.

3. The parallel operation apparatus of claim 1, wherein
the task switching control unit
further includes a priority control subunit operable to control a priority of a task processed in the first processor,
after starting application of the second mode, starts processing of the type 1 task in accordance with the priority thereof on receipt of the notification of the execution completion,
upon instructing the second processor to start the second processing, starts application of the second mode by causing the priority control subunit to raise the priority of the type 2 task over the priority of the type 1 task,
from application of the second mode until the predetermined time has elapsed, prevents application of the first mode by causing the priority control subunit to raise the priority of the type 2 task over the priority of the type 1 task, and
after the predetermined time has elapsed, starts application of the first mode by causing the priority control subunit to raise the priority of the type 1 task over the priority of the type 2 task.

4. The parallel operation apparatus of claim 2, wherein
the task switching control unit sets the predetermined time to a predetermined fixed value.

5. The parallel operation apparatus of claim 3, wherein
the task switching control unit sets the predetermined time to a predetermined fixed value.

6. The parallel operation apparatus of claim 2, wherein
the first processor further includes a measurement subunit operable to measure an application period during which the first mode is applied, and
the task switching control unit determines the predetermined time according to the application period that was applied until the instruction was performed.

7. The parallel operation apparatus of claim 3, wherein
the first processor further includes a measurement subunit operable to measure an application period during which the first mode is applied, and
the task switching control unit determines the predetermined time according to the application period that was applied until the instruction was performed.

8. The parallel operation apparatus of claim 6, wherein
the task switching control unit determines the predetermined time such that the predetermined time and the application period are in a constant ratio.

9. The parallel operation apparatus of claim 7, wherein
the task switching control unit determines the predetermined time such that the predetermined time and the application period are in a constant ratio.

10. The parallel operation apparatus of claim 1, wherein
the task switching control unit
further includes a processing request delay subunit operable to receive a predetermined delay time setting, and, from when the first processor performs the instruction until the predetermined delay time has elapsed, delay the start of processing execution by the second processor,
upon performing the instruction, sets the delay time in the processing request delay subunit and starts application of the second mode,
prevents application of the first mode until the notification of the execution completion is received, and
starts application of the first mode upon receiving the notification of the execution completion.

11. The parallel operation apparatus of claim 1, wherein
the task switching control unit
further includes a completion notification delay unit operable to receive a predetermined delay time, and delay reception of the notification of the execution completion from the second processor until the predetermined delay time has elapsed,
when performing the instruction, sets the delay time in the completion notification delay subunit and starts application of the second mode,
prevents application of the first mode until the notification of the execution completion is received, and
starts application of the first mode upon receiving the notification of the execution completion.

12. The parallel operation apparatus of claim 1, wherein
the first processor further includes a sub processor control unit operable to receive a predetermined delay time setting, and, when the second processor is executing processing, cause the execution of the processing to be stopped for the predetermined delay time, and
the task switching control unit,
when performing the instruction, sets the predetermined delay time in the sub processor control unit and starts application of the second mode,
upon performing the instruction to cause the second processor to execute processing, causes the sub processor control unit to stop the processing for the predetermined delay time,
prevents application of the first mode until the notification of the execution completion is received from the sub processor control unit, and
starts application of the first mode upon receiving the notification of the execution completion.

13. The parallel operation apparatus of claim 10, wherein
the task switching control unit sets the delay time to a predetermined fixed value.

14. The parallel operation apparatus of claim 11, wherein
the task switching control unit sets the delay time to a predetermined fixed value.

15. The parallel operation apparatus of claim 12, wherein
the task switching control unit sets the delay time to a predetermined fixed value.

16. The parallel operation apparatus of claim 10, wherein
the first processor further includes
a measurement subunit operable to measure an application period during which the first mode is applied, and
a processing period estimation unit operable to estimate a processing period based on the instruction, the notification of the execution completion, and the predetermined delay time, the processing period being a period during which the second processor performed processing, and
the task switching control unit determines the predetermined time according to the application period that was applied until performing the instruction, causes the delay time to be a difference between the predetermined time and the estimated processing period, and performs the setting of the delay time.

17. The parallel operation apparatus of claim 11, wherein
the first processor further includes
a measurement subunit operable to measure an application period during which the first mode is applied, and
a processing period estimation unit operable to estimate a processing period based on the instruction, the notification of the execution completion, and the predetermined delay time, the processing period being a period during which the second processor performed processing, and
the task switching control unit determines the predetermined time according to the application period that was applied until performing the instruction, causes the delay time to be a difference between the predetermined time and the estimated processing period, and performs setting of the delay time.

18. The parallel operation apparatus of claim 12, wherein
the first processor further includes
a measurement subunit operable to measure an application period during which the first mode is applied, and
a processing period estimation unit operable to estimate a processing period based on the instruction, the notification of the execution completion, and the predetermined delay time, the processing period being a period during which the second processor performed processing, and
the task switching control unit determines the predetermined time according to the application period that was applied until performing the instruction, causes the delay time to be a difference between the predetermined time and the estimated processing period, and performs the setting of the delay time.

19. A task switching method for a parallel operation apparatus which is for processing a plurality of sequentially generated tasks by time-division and includes a first processor and a second processor that receives an instruction from the first processor, executes processing, and notifies execution completion, the task switching method comprising:
a task switching control step of
switching task processing by selectively applying (i) a first mode in which the first processor executes a type 1 task with priority after executing a first processing, the type 1 task causing the second processor to start a second processing, and (ii) a second mode in which, when there is a type 2 task that the first processor can process independently, the first processor executes the type 2 task regardless of the existence of the type 1 task, and
applying the second mode upon the first processor executing the type 1 task to instruct the second processor to start the second processing, preventing application of the first mode for at least a predetermined time after applying the second mode, and applying the first mode when the second processing has been completed and the predetermined time has elapsed.

20. An information processing apparatus using the parallel operation apparatus of claim 1.
